(19) United States
(12) Patent Application Publication
(10) Pub. No.: US 2021/0172031 A1
(43) Pub. Date: Jun. 10, 2021

(54) PRODUCTION OF WHITE SUGARS AND HIGH-QUALITY LIQUID SUGARS

(71) Applicant: SUCRO CAN SOURCING LLC, Miami, FL (US)

(72) Inventor: Jonathan Taylor, Miami, FL (US)

(21) Appl. No.: 17/047,816

(22) PCT Filed: Apr. 25, 2019
(86) PCT No.: PCT/US2019/029063

§ 371 Date: Oct. 15, 2020

Related U.S. Application Data
(60) Provisional application No. 62/668,404, filed on May 8, 2018.

(51) Int. Cl. C13B 25/00; C13B 50/00; C13B 20/14

(52) U.S. Cl. CPC C13B 25/008; C13B 20/14; C13B 50/00; C13B 25/001

(57) ABSTRACT

Provided herein is a system and method for the parallel production of white sugar and high-quality liquid sugar from higher run-off/run-offs utilizing one vacuum pan.

### FIELD OF THE INVENTION

The invention is directed to a versatile, small-to-medium capacity, refining unit for the production of white sugars and liquid sugars from a raw sugar source such as, for example, crystal sugar in general, raw sugar in general, VHP sugar (Very High Polarization sugar), VVHP sugar (Very Very High Polarization sugar), magma B or C (intermediary products of the conventional process of producing crystal sugar) and mixtures of said sugars.

All publications, patents, patent applications, and other references cited in this application are incorporated herein by reference in their entirety for all purposes and to the same extent as if each individual publication, patent, patent application or other reference was specifically and individually indicated to be incorporated by reference in its entirety for all purposes. Citation of a reference herein shall not be construed as an admission that such is prior art to the present invention.

### BACKGROUND OF THE INVENTION

In typical sugar refineries, only about 81% of refined sugar is typically produced from 100% raw sugar, with the remainder considered inferior raw feed syrup because of the higher color content. Indeed, in a typical sugar refinery, the final sugar residuals are considered as a very dense molasses and eventually waste. Such low yields and loss motivates most refineries to spend significantly more on vacuum pans and related technologies to reprocess the remaining 20% of the feed, in multiple stages of sugar processing, in order to achieve the industry standard refined sugar.

A need exists in the art, therefore, for an efficient and simplified process for the production of white and liquid sugar from a raw sugar source which achieves efficiencies in, for example, yield and costs beyond what is currently achievable in the art.

### SUMMARY OF THE INVENTION

Provided is a system and process of manufacturing white and liquid sugar in parallel from a raw sugar source using one vacuum pan.

### BRIEF DESCRIPTION OF THE DRAWINGS

FIGS. 1A to 1C are schematics showing an embodiment of the sugar manufacturing process of the invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical sugar manufacturing processes. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

This invention is related to versatile small-to-medium capacity refining unit for production of white and liquid sugar form HP-VHP raw sugars. As used herein, HP refers to high polarization sugar which can be obtained from Brazil having a range of 98-99.3 polarization. As used herein, VHP refers to very high polarization sugar that can be obtained from, for example, South American and Central American countries such as Brazil, Colombia, Costa Rica and Nicaragua. In another embodiment, VVHP (very very high polarization sugar over 99.5 polarization) can also be used as a raw sugar source in the process of the invention.

The inventor has found that disadvantages in the art may be overcome and therefore, an innovative system is proposed that shortens the break in processing and eliminates multiple vacuum pans. In one embodiment of the invention, sugar is directly subjected to a one vacuum model that produces the standard refined sugar, white sugars and high-quality liquid sugar. According to analysis of the mass balance sheet, it is possible to reprocess the run offs as marketable sugar. This inherently allows for the reduction in processing versus industry standard by 25% by eliminating the need of multiple evaporation processes. The innovative process further allows for the conversion of the final sugar residuals in high quality liquid sugar. As a result, production is increased by repurposing the run-off coloured sugar more efficiently with the added advantage of having zero losses during the process.

The invention will now be further described in the Examples below, which are intended as an illustration only and do not limit the scope of the invention.

### EXAMPLES

### Example 1

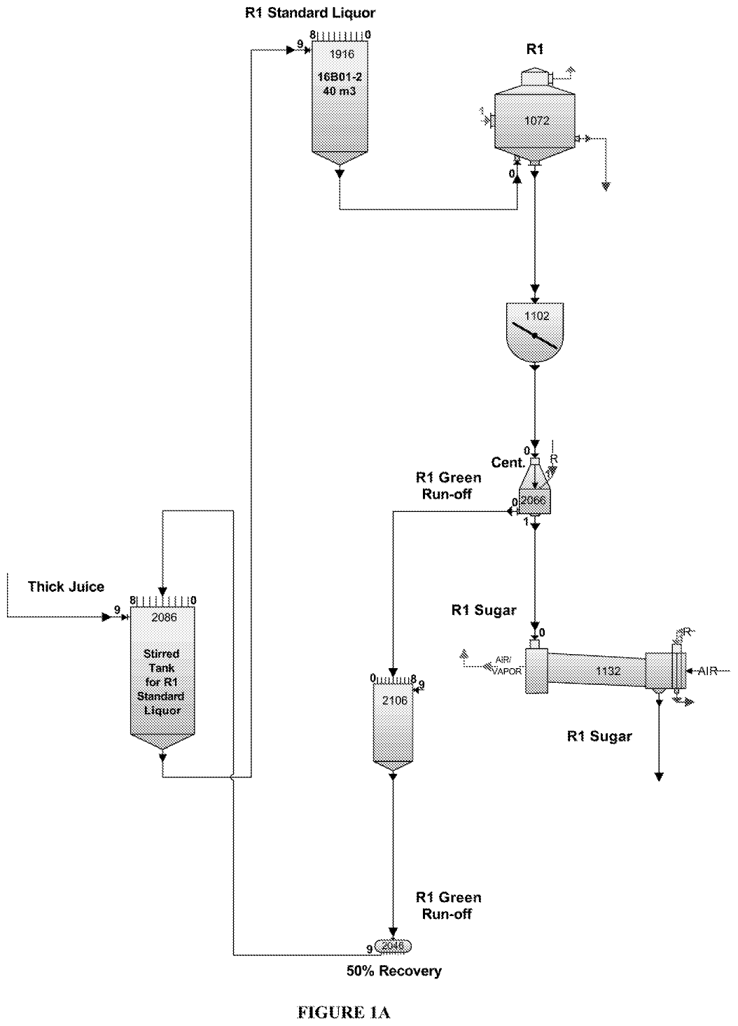

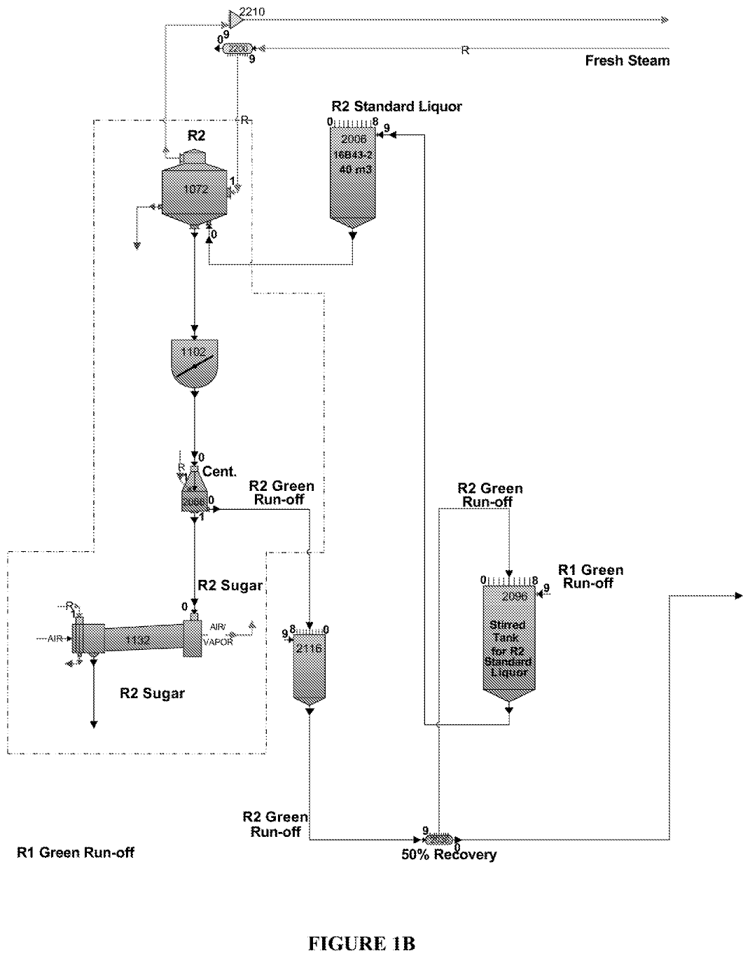

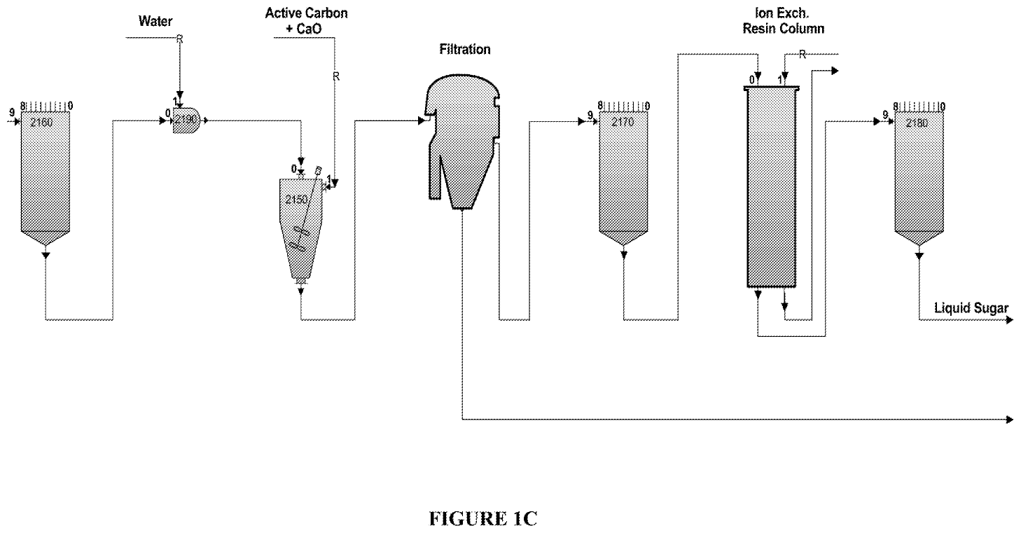

FIGS. 1A, 1B and 1C schematically outline an embodiment of the invention. As shown in FIG. 1A, thick Juice at 70° C., 67.5% brix, 99.60 purity and 200 ICUMSA will be stored in tanks (2086) the syrup will be mixed in tank 1916. R1 Standard liquor with 68.9° C., 69.34% brix, 99.40 purity and 327 ICUMSA will then feed through the vacuum pan (1072) where the first crystals will form and then it gets separated in the centrifuge and finally gets dried in a rotary drum dryer. In this process from 17.51 t/hr only 8.34 t/hr of refined sugar with 99.99 brix, 99.99 purity and 15 ICUMSA will be processed the remaining 9.76 t/h with 64.9° C., 76.08 brix, 98.73 purity and 740 ICUMSA will be stored in tank (2106).

50% of the green run-off from R1 will then get recirculated back in the feed tank (2086) and the remaining 4.88 t/hr will be stored as R1 Green Run off in tank (2096) as shown in FIG. 1B. The syrup will then get mixed in tank (2006) and will form R2 standard liquor with the following condition 64.9° C., 76.70 brix, 98.12 purity and 1253 ICUMSA. R2 standard liquor will then feed through the same vacuum pan (1072) as shown in FIG. 1A where the second crystal will form and then gets separated in the centrifuge and finally gets dried in a rotary drum dryer. 2.47 t/hr of white sugar will get recovered with 99.99 brix, 99.96 purity and 37 ICUMSA and the remaining 2.28 will be stored in tank (2116).

50% of the R2 green run off will get recirculated back as the feed in R2 standard liquor and the remaining sugar residues with a very high colour of 2786 ICUMSA, 64.8° C., 78.64 Brix and 96.28 purity will be stored in tank (2160) as shown in FIG. 1C. Final sugar residues that are very high in colour are recovered by introducing activated carbon with a minimum of 4 hours retention time to decrease the colour of the sugar by 60% to 1115 ICUMSA. The syrup will then go through the filtration step where the brix of the syrup is dropped to 67.5% from 78.64% by adding water at 70° C. All the solids will be filtered through the Vertical pressure leaf filter and stored at tank (2170). Finally, the syrup at 65° C., 67.83% brix and 1115 ICUMSA colour will go through another decolourization step which is ion exchange resins. In this step, a styrenic resin is used from the Purolite Corporation called 502S which has 85% decolorizing capacity. The final syrup will be stored in tank (2180) with 200 ICUMSA, 65° C. and 67.8 Brix.

The invention will be further described, without limitation, by the following numbered paragraphs:
1. A system for the parallel production of white and liquid sugar from a raw sugar source, comprising one vacuum pan as the sole vacuum pan in said system.
2. A process for the parallel production of white and liquid sugar from a raw sugar source utilizing the system according to paragraph 1.
3. The process according to paragraph 2, wherein said raw sugar source is selected from the group consisting of crystal sugar, raw sugar, very high polarization sugar, very very high polarization sugar, magma B or C intermediary products from the conventional process of producing crystal sugar and mixtures of said sugars
4. The process according to paragraph 2, wherein partial recovery of a first run off comprises refined sugar and partial recovery of a second run off comprises white sugar.
5. The process according to paragraph 2, wherein liquid sugar is an end product of said process.
6. A process for the production of white and liquid sugar from a system comprising one vacuum pan, comprising the steps of:
   melting of a raw sugar source;
   purifying said melted raw sugar by phosphatation to produce a clarified sugar solution;
   batch crystallization of said clarified sugar solution with starting colour of 400-500 IU to white sugar with colour up to 30 IU;
   partial recovery of a first run-off up to 50% of its volume and collection of residual run-off for next crystallization step;
   batch crystallization of a second run-off to white sugar with colour up to 60 IU;
   partial recovery of up to 50% of second run-off back to crystallization;
   admixing of both first and second sugars as a product; and
   purifying residual second run-off as a liquid sugar using active carbon, filtration and ion-exchange.

It is to be understood that the invention is not limited to the particular embodiments of the invention described above, as variations of the particular embodiments may be made and still fall within the scope of the appended claims.

What is claimed is:

1. A system for the parallel production of white and liquid sugar from a raw sugar source, comprising one vacuum pan as the sole vacuum pan in said system.

2. A process for the parallel production of white and liquid sugar from a raw sugar source utilizing the system according to claim 1.

3. The process according to claim 2, wherein said raw sugar source is selected from the group consisting of crystal sugar, raw sugar, very high polarization sugar, very very high polarization sugar, magma B or C intermediary products from the conventional process of producing crystal sugar and mixtures of said sugars

4. The process according to claim 2, wherein partial recovery of a first run off comprises refined sugar and partial recovery of a second run off comprises white sugar.

5. The process according to claim 2, wherein liquid sugar is an end product of said process.

6. A process for the production of white and liquid sugar from a system comprising one vacuum pan, comprising the steps of:
melting of a raw sugar source;
purifying said melted raw sugar by phosphatation to produce a clarified sugar solution;
batch crystallization of said clarified sugar solution with starting colour of 400-500 IU to white sugar with colour up to 30 IU;
partial recovery of a first run-off up to 50% of its volume and collection of residual run-off for next crystallization step;
batch crystallization of a second run-off to white sugar with colour up to 60 IU;
partial recovery of up to 50% of second run-off back to crystallization;
admixing of both first and second sugars as a product; and
purifying residual second run-off as a liquid sugar using active carbon, filtration and ion-exchange.
